(19) United States
(12) Patent Application Publication
(10) Pub. No.: US 2020/0235497 A1
(43) Pub. Date: Jul. 23, 2020

(54) Line And Method For Producing A Line

(71) Applicant: LEONI KABEL GMBH, NUERNBERG (DE)

(72) Inventors: DOMINIK DORNER, PLEINFELD (DE); ERWIN KOEPPENDOERFER, SCHWABACH (DE); JOHANNES NACHTRAB, WINDSBACH (DE); RAINER POEHMERER, WINKELHAID (DE)

(21) Appl. No.: 16/466,668

(22) PCT Filed: Dec. 4, 2017
(86) PCT No.: PCT/EP2017/081382

§ 371 Date: Jun. 5, 2019

(30) Foreign Application Priority Data
Dec. 5, 2016 (DE) 10 2016 224 107.9

(51) Int. Cl. H01R 4/18; H01R 43/048; H01B 11/00

(52) U.S. Cl. CPC H01R 4/183; H01B 11/00; H01R 43/048

(57) ABSTRACT

A data line or cable, in particular a high frequency line, has a hollow conductor, which is formed from a conductive material, and surrounds a cavity. A crimp is fastened to the hollow conductor, which crimp is pressed onto the hollow conductor, and the material is displaced into the cavity. The problem addressed is that of specifying a line that is provided with a crimp and that has the best possible transmission properties.

The invention relates to a line, in particular an RF line, and also to a method for producing a line of this kind.

In order to be able to connect an electrical line at the end side, said electrical line is often provided with a contact element which is fastened to a conductor of the line by means of a crimp. The crimp is usually a sleeve composed of a conductive material which is placed onto the end of the conductor, which is stripped of insulation, and is firmly pressed there. In this way, the crimp is pressed around the conductor and fastened to the line in a force-fitting manner. The crimp is necessarily deformed in the process, as is the conductor.

A commonly used crimp is the so-called B-crimp which has a B-shaped cross section and has a base starting from which two bent arms extend, the ends of said arms being bent inward when the crimp is fitted. In the process, the arms engage into the conductor and deform said conductor, with the result that the original shape and cross-sectional geometry of said conductor is not retained. The conductor is often compressed and flattened or even split in one direction in the process. Since the crimp is usually composed of conductive material and is directly connected to the conductor, the crimp itself also makes a contribution to a possibly disadvantageous change in the cross-sectional geometry at the end of the line.

A deformation of the conductor and a change in the cross-sectional geometry have a disadvantageous effect on the transmission properties of the line, for example if said line is designed as a signal line for data transmission. A crimp has a disadvantageous effect particularly in the case of radio-frequency lines, RF lines for short, since, in the case of RF lines of this kind, a large portion of the transmitted current is transported on the outer side on account of the skin effect and is accordingly highly influenced by a changed cross-sectional geometry. Deformation of the conductor by pressing a crimp against it generally leads to impaired transmission properties, that is to say to an impaired transmission quality overall.

Against this background, the object of the invention is to specify a line which is provided with a crimp and, in the process, has transmission properties which are as good as possible. Furthermore, a method for producing a line of this kind is intended to be specified.

According to the invention, the object is achieved by a line having the features as claimed in claim 1 and also by a method having the features as claimed in claim 13. Advantageous refinements, developments and variants are the subject matter of the dependent claims. Here, the statements in connection with the line also apply, mutatis mutandis, to the method and vice versa.

The line is, in particular, an RF line, that is to say a radio-frequency line, and as a result suitable for transmitting signals or data at frequencies in the gigahertz range, in particular in the range of between 5 and 10 GHz or more. The line is designed, in particular, as a signal or data line. The line has, as the conductor, a hollow conductor which is composed of a conductive material, for example copper or aluminum. The conductive material surrounds a cavity, that is to say the hollow conductor is hollow on the inside.

The hollow conductor is, in particular, round, as is the cavity in particular. The hollow conductor is preferably hollow, that is to say the cavity is empty, that is to say in particular filled only with air. Additional functional elements are not present and also not provided in the interior of the hollow conductor, that is to say in the cavity, in order to ensure optimum current conduction and to comply with corresponding specifications and standards in this respect. The line is, in particular, a coaxial line. In a suitable refinement, the line is designed as a simple core, that is to say as an insulated conductor, wherein the hollow conductor is then surrounded by an insulating sheath.

A crimp is fastened, in particular at the end side, to the hollow conductor, specifically to a crimping point on the line. The crimp is pressed against the hollow conductor, wherein the material of the hollow conductor is displaced into the cavity, with the result that the crimp engages around the hollow conductor and in the process reduces the size of or compresses the cavity in particular. Within the crimp, the cavity is tapered or even entirely closed as a result. The hollow conductor therefore has a reduced inside diameter within the crimp, wherein said inside diameter can also be zero. The material forms a wall of the hollow conductor, which wall has a reduced outside diameter in the region of the crimp. The hollow conductor is therefore compacted overall, that is to say compressed by utilizing the cavity, by means of the crimp. The crimp itself has a certain wall thickness which forms a total diameter when added to the outside diameter of the hollow conductor. The material of the hollow conductor and the cavity together, that is to say when added, define a hollow conductor cross section which is reduced by the crimp by way of the share of the cavity in the hollow conductor cross section being reduced.

For production purposes, the crimp is fastened to the hollow conductor by way of the crimp being pressed against the hollow conductor. In the process, the material is displaced into the cavity, with the result that the crimp engages around the hollow conductor and compresses, in particular, the hollow conductor and the cavity. The hollow conductor is therefore advantageously locally compacted by the crimp and then takes up less space there than along the rest of the line.

A core concept of the invention is, in particular, that of maintaining the total outside diameter and, in general, the cross-sectional geometry of the line at the crimping point as far as possible and, when fastening the crimp, of deforming said total outside diameter and cross-sectional geometry as little as possible. To this end, the crimp is incorporated in the cross-sectional geometry. This is based on the consideration that the crimp itself has a certain wall thickness and conventionally leads to a protrusion or a thickened portion in the radial direction, that is to say perpendicularly in relation to the longitudinal direction of the line, on a conductor. This results in a total outside diameter at the crimping point which is usually larger than the outside diameter of the conductor outside the crimp. However, a changed diameter of this kind along the line disadvantageously forms an impedance interference point which leads to reflections and ultimately to an impaired transmission quality of the line. This systematic fault and its disadvantageous effect is reduced or entirely avoided in the present case by way of the conductor being a hollow conductor with a cavity which renders possible an improved redistribution of the material when it is compressed by the crimp. In this case, the cavity firstly provides space for the material of the conductor and secondly, depending on the configuration of the crimp, in particular also provides space for the material of the crimp itself. The arrangement comprising the conductor and the crimp is then advantageously compressed in such a way that the cavity receives material and in this way is partially or entirely closed, as a result of which the diameter of the arrangement comprising the crimp and the hollow conductor, that is to say the total outside diameter at the crimping point, per se is particularly slightly changed or is not changed at all in comparison to the outside diameter of the hollow conductor.

The cavity is arranged preferably centrally with respect to the hollow conductor and then extends centrally along said hollow conductor. An arrangement of this kind is particularly suitable for an RF line in respect of the skin effect. The arrangement is also particularly suitable for a coaxial line. In addition, the cavity is expediently of continuous design, that is to say free of interruptions. In principle, an interruption is produced only at the crimping point under certain circumstances since the cavity for all intents and purposes tapers or is entirely closed here. The hollow conductor is, in general, in particular of rotationally symmetrical design, that is to say the hollow conductor runs in an annular manner around the cavity. In particular, the hollow conductor is generally not slotted or split, but rather the cavity is instead surrounded by conductive material over its entire circumference.

The hollow conductor is expediently of multipartite design and consists of a plurality of individual wires. In other words: the hollow conductor is made up of a plurality of individual wires. Here, the individual wires are arranged in an annular manner. Furthermore, the individual wires bear against one another and specifically are not spaced apart from one another. This is understood to mean that in each case two adjacent individual wires bear against one another, whereas opposite individual wires do not make contact, at least in the uncompacted state, but rather are spaced apart from one another by the cavity. In this refinement, particularly uniform compaction is possible since the individual wires are compressed, in particular uniformly, in the direction of the cavity here. In this case, the individual wires are preferably of identical design, that is to say they have the same cross section, with the result that a particularly high degree of symmetry is produced overall.

Interlocking of the individual wires with one another is preferably dispensed with, that is to say the individual wires are designed without interlocking means or profiles. Two respectively adjacent individual wires then bear against one another in such a way that a boundary surface which faces radially outward and along which the individual wires move for all intents and purposes during compaction is produced. Said individual wires can be pushed together particularly easily on account of an interlocking arrangement being dispensed with.

In a particularly preferred refinement, the individual wires are each of droplet-shaped design. “Droplet-shaped” is understood to mean, in particular, that a respective individual wire, as viewed in cross section, has an outer contour which has only one single pointed portion and otherwise is round. The droplet shape of the individual wires advantageously leads to the individual wires, when they are compressed, being guided along one another for all intents and purposes and in this way being displaced in a particularly defined, that is to say uniform, manner and the hollow conductor being deformed in a correspondingly defined manner. The pointed portion forms, in particular, an angle in the range of from 10° to 170°, preferably of from 45° to 90°. The pointed portion is, in particular, directed inward, that is to say oriented toward the cavity and protrudes into said cavity. The pointed portions do not necessarily bear against one another, with the result that the cavity is of star-shaped cross section in general.

In a suitable refinement, the individual wires are of droplet-shaped design overall, that is to say along their entire length. As an alternative, the individual wires are of droplet-shaped design only in the region of the crimp.

A particular advantage of the invention is, in particular, that the line has a crimping point which is of particularly low construction. This is rendered possible, in particular, by the use of a hollow conductor. In an advantageous refinement, the hollow conductor has an outside diameter and the crimp forms a protrusion, which is at most 10% of the outside diameter, in the radial direction and with respect to the hollow conductor. In conventional lines and with conventional methods, considerably larger protrusions, for example of approximately 50%, are typically produced. However, in the present case, a particularly low protrusion which leads to considerably improved transmission properties as a result is rendered possible owing to the collapse of the cavity.

In a particularly advantageous refinement, the line extends in a longitudinal direction and the crimp and the hollow conductor are in alignment in the longitudinal direction. The crimp specifically does not form a protrusion in this case, and a disadvantageous thickened portion at the crimping point is entirely avoided. Particularly good transmission properties of the line are realized in this way. This is particularly advantageous in the case of an RF line of which the transmission properties are substantially dependent on the diameter of the conductor. In the fastened state, the crimp then has an outside diameter which corresponds to the outside diameter of the hollow conductor along the line, with the result that a constant outside diameter for current conduction is realized in the longitudinal direction.

The hollow conductor is preferably designed as a stranded conductor and in this case has a plurality of individual wires which are arranged around the cavity. The individual wires advantageously form a supporting structure, wherein each of the individual wires constitutes a segment and the segments are supported against one another. A particularly stable, hollow stranded conductor is realized in a simple manner in this way. The above statements relating to the individual wires of a generally multipartite hollow conductor correspondingly apply to the individual wires of a hollow conductor which is designed as a stranded conductor too.

In a preferred refinement, the conductor is a stranded conductor with an arrangement of the individual wires which is based on a conventional 1+6 construction in which a central individual wire is surrounded by a layer of six further individual wires. In order to form a hollow conductor, the central individual wire is dispensed with, with the result that six individual wires are then grouped around a cavity. The cavity then has, in particular, an inside diameter which corresponds to a diameter of a single individual wire. Material and weight are saved in this way.

The individual wires are suitably round. In a suitable variant, the individual wires are of triangular cross section. In an alternative refinement, the individual wires are formed in a segmented manner in cross section, for example in a trapezoidal manner, in the form of a segment of a ring or the like. In one variant, one layer of individual wires is surrounded by one or more further layers of individual wires. As an alternative or in addition, six individual wires are not grouped around the cavity, but rather a different number of individual wires are grouped around said cavity. However, a refinement in which the hollow conductor has an even number of individual wires is particularly preferred, with the result that a particularly high degree of symmetry is produced. As an alternative or in addition to this, only one layer of individual wires is preferably formed, that is to say all of the individual wires are arranged in an annular manner in a single ring and specifically not in a plurality of layers and on a plurality of concentric rings. However, a multilayer configuration of this kind is also suitable in principle. In general, it is important, in particular, for the cavity to be completely surrounded by material in the radial direction in order to ensure good current carrying.

Various suitable variants are conceivable for the crimp. In all variants, it is important, in particular, for the crimp to be of particularly low construction after being fastened to the hollow conductor and for a conductive cross section of the line, which cross section is optimal in respect of the transmission properties, to be formed at the crimping point overall.

A refinement in which the cavity is completely closed, that is to say has completely collapsed, in the region of the crimp after being fastened to the hollow conductor is particularly preferred. In other words: the line is preferably designed in such a way that the cavity can be completely closed, compressed or collapsed. “In the region of the crimp” is understood to mean, in particular, a longitudinal section of the hollow conductor which is arranged within the crimp, that is to say around which the crimp engages or which is enclosed by the crimp. Therefore, the crimp encloses a longitudinal section of the hollow conductor and the hollow conductor is compressed over this longitudinal section in such a way that the cavity is completely closed.

In a first advantageous refinement, the crimp is designed as a B-crimp with two arms which engage around two holding regions, and wherein the material is distributed uniformly over the two holding regions of the crimp. Here, the crimp is, in particular, a conventional B-crimp. A crimp of this kind usually leads to a big change in the conductive cross section since the crimp, when it is pressed against, is typically compressed until it is flat. In particular, the conductor is also split as a result and the material of the conductor is inhomogeneously divided between the two holding regions. Particularly in the case of a conventional stranded conductor with a central individual wire, for example of the above-described 1+6 configuration, the material of the conductor is also non-uniformly distributed on account of the uneven number of individual wires.

However, in the case of a hollow stranded conductor, a mirror-symmetrical configuration with an even number of individual wires is possible, this leading to a uniform distribution of material in the crimp. Improved transmission properties are accordingly produced. The use of a hollow conductor therefore already leads to a considerable improvement in comparison to a conventional conductor when a B-crimp is used.

In a second advantageous refinement, the crimp is designed as a round crimp and the hollow conductor collapses inward, that is to say in particular into the cavity, within the crimp. This leads to an overall particularly round crimping point with correspondingly particularly good transmission properties. This is advantageous particularly in the case of an RF line. The round crimp is, for example, a sleeve or formed in a cup-shaped manner. The round crimp is either of integral or multipartite design. When the crimp is compressed on the hollow conductor, said crimp and hollow conductor are compressed and as a result forced into the cavity, the inside diameter of which is correspondingly reduced or completely closed. The hollow conductor collapses at the crimping point for all intents and purposes and as a result renders possible a particularly small total outside diameter.

The crimp serves, in particular, to stop a contact element, in particular a plug-in connector, which is connected to the hollow conductor in order to then connect the line to a device or the like. The contact element is accordingly fastened to the crimp, for example compressed or soldered in the crimp together with the hollow conductor. In this way, the line is then designed as a prefabricated line with a contact element which is fastened, in particular at the end side, to the hollow conductor. Here, the crimp serves for all intents and purposes as an intermediary between the hollow conductor and the contact element. In one variant, the line is provided with a crimp and possibly also with a contact element at both ends.

In one embodiment, a contact element is fastened to the crimp, as described above. Said contact element then preferably has a supporting section which is inserted into the cavity and is compressed in said cavity. An advantageous supporting effect is provided by means of the supporting section, as a result of which excessive deformation of the hollow conductor is prevented. This is understood to mean that the hollow conductor is still deformed and, in particular, compressed, but the deformation takes place particularly uniformly owing to the supporting section. To this end, the supporting section is pushed or inserted into the cavity when the crimp is put into place. Particularly in the case of a stranded conductor and generally in the case of a multipartite hollow conductor, the supporting section prevents an individual wire from slipping inward to all intents and purposes and as a result disrupting the advantageous symmetry of the arrangement. The supporting section is produced, in particular, from the same material as the rest of the crimp and is, for example, integrally formed on said crimp.

The supporting section is, in particular, of pin-like design, that is to say designed as a pin. In a preferred refinement, the supporting section is of hollow design, that is to say designed as a sleeve. As a result, the supporting section itself can be compressed, like the hollow conductor and the crimp, and when fastening the crimp is compressed just like the hollow conductor in order to realize a particularly small total outside diameter overall.

A tool which preferably has a plurality of pressing jaws is used for fastening the crimp to the hollow conductor. Said pressing jaws are positioned around the crimp and moved toward one another in the radial direction in order to compress the crimp with the hollow conductor. The tool is expediently of symmetrical design and the pressing jaws are expediently arranged in an annular manner, with the result that a particularly uniform force effect is produced in the radial direction. As a result, the crimp and the hollow conductor are deformed in a particularly homogeneous manner. The greater the number of pressing jaws the tool has, the more homogeneous the deformation and the rounder the crimp remains after the pressing operation, together with corresponding advantages in respect of the transmission properties. The tool suitably has four, six or eight pressing jaws.

Exemplary embodiments of the invention will be explained in more detail below with reference to a drawing, in which in each case schematically:

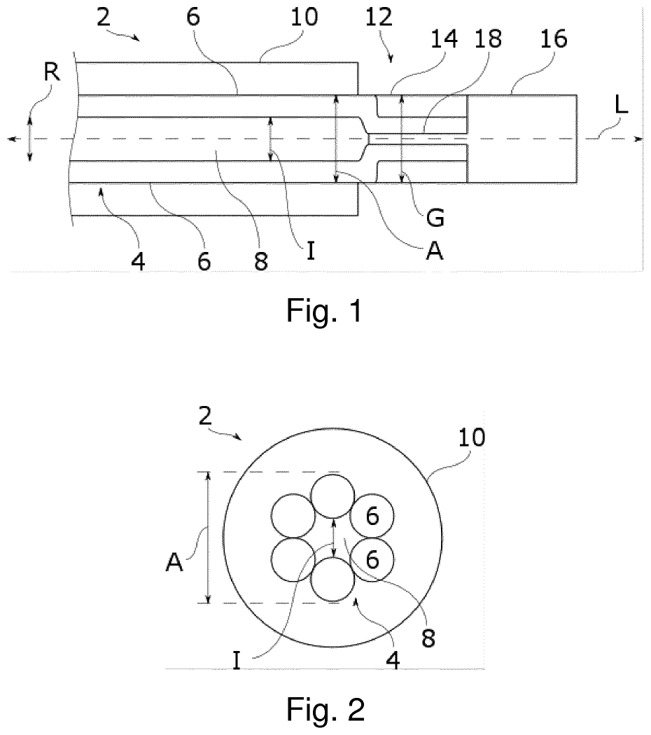

FIG. 1 shows a longitudinal sectional view through a line,

FIG. 2 shows a first cross-sectional view through the line,

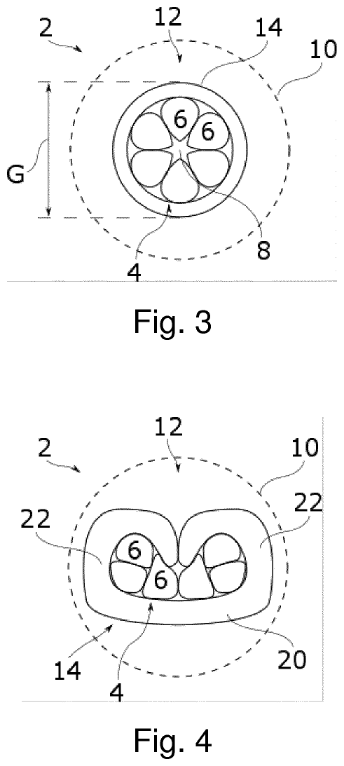

FIG. 3 shows a second cross-sectional view through the line, and

FIG. 4 shows a cross-sectional view through a variant of the line.

FIG. 1 shows a line 2 which is designed as an RF line and is designed to transmit signals or data, in particular, in the frequency range of between 5 and 10 GHz or more. The line 2 extends in a longitudinal direction L and is illustrated in a sectional view along the longitudinal direction L in FIG. 1. The line 2 has, as the conductor, a hollow conductor 4 which is designed as a stranded conductor comprising a plurality of individual wires 6 which are arranged around a cavity 8 of the hollow conductor 4. In the exemplary embodiment shown, only one layer of individual wires 6 is shown but the hollow conductor 4 consists of a plurality of layers of individual wires 6 in a variant which is not shown. The hollow conductor has an outside diameter A and an inside diameter I which corresponds, in particular, to a diameter of an individual wire. Furthermore, the hollow conductor 4 is surrounded by an insulating sheath 10 in the exemplary embodiment shown here.

A crimp 14 is fastened to the hollow conductor 4 at a crimping point 12 at an end side of the line 2. The crimp 14 shown here is designed as a round crimp. The crimp 14 serves, in particular, to stop a contact element 16, for example of a plug-in connector, which is only highly schematically illustrated in FIG. 1. The crimp 14 is pressed against the hollow conductor 4, wherein the material of said hollow conductor is displaced into the cavity 8, with the result that the crimp 14 engages around the hollow conductor 4 and compresses the cavity 8. Therefore, the cavity 8 tapers at the crimping point 12. As a result, the crimp 14 is of particularly low construction overall, that is to say has a particularly low protrusion in the radial direction R with respect to that part of the hollow conductor 4, which part is not compressed, outside the crimping point 12. In the present case, no protrusion at all is formed, with the result that the crimp 14 and the hollow conductor 4 are in alignment in the longitudinal direction L. In other words: the crimp 14 with the hollow conductor 4 has, in the fastened state, a total outside diameter G which corresponds to the outside diameter A of the hollow conductor 4, as shown in FIG. 1. This leads to considerably improved transmission properties since the formation of an impedance interference point by a changed diameter is avoided. This is possible primarily on account of the cavity 8 into which the material can collapse and be displaced when the crimp 14 is pressed against. The crimp 14 is fastened, for example, by means of a tool having a plurality of pressing jaws which are arranged in an annular manner around the crimp 14 and are then moved inward in order to compress the crimp 14.

In order to deform the hollow conductor 4 in a particularly uniform manner when it is compressed, the contact element 16 has a supporting section 18 which is of pin-like design here and is inserted into the cavity 8. As an alternative, the supporting section 18 is of hollow, that is to say sleeve-like, design and is in this case, in particular, also compressed. The supporting section 18 is integrally formed on the contact element 16 in the present case.

FIGS. 2 and 3 each show the line 2 in a sectional view transverse in relation to the longitudinal direction L, specifically at a point of the line 2 at which the hollow conductor 4 is not compressed in FIG. 2, and at the crimping point 12 in FIG. 3. Upon comparison of the two figures with one another, it is immediately clear that the inside diameter I of the hollow conductor 4 is produced at the crimping point 12. The individual wires 6 are pushed into the interior and compacted. As a result, the cross-sectional shape of the individual wires 6 has also changed in particular. In the exemplary embodiment shown, the individual wires 6 are of droplet-shaped cross section, that is to say each have a droplet shape. In a variant which is not shown, the individual wires 6 are already compacted along the entire line 2, with a corresponding cross-sectional shape, and then moved closer to the crimping point 12. Overall, the individual wires 6 form a supporting structure and are supported against one another.

FIG. 4 shows a variant of the line 2 in which a B-crimp is used instead of the round crimp of FIGS. 1 to 3. Said B-crimp is of B-shaped cross section, with a base 20 starting from which two bent arms 22 extend, the ends of said arms being bent inward when the crimp 14 is fitted. In the process, the arms 22 engage around the individual wires 6. On account of the cavity 8 and the even number of individual wires 6, the material is distributed uniformly over the two arms 22, with the result that a crimping point 12 with improved transmission properties can also be realized for the line 2 on account of the use of a hollow conductor 4.

1-13. (canceled)

14. A radio frequency data line, comprising:
a hollow conductor composed of a conductive material surrounding a cavity; and
a crimp fastened to and pressed against said hollow conductor, wherein said conductive material being displaced into said cavity.

15. The RF data line according to claim 14, wherein said hollow conductor is of a multipartite configuration formed of a plurality of individual wires, said individual wires are disposed in an annular manner and bear against one another.

16. The RF data line according to claim 15, wherein said individual wires are each droplet-shaped.

17. The RF data line according to claim 14, wherein:
said hollow conductor has an outside diameter; and
said crimp has a protrusion, which is at most 10% of said outside diameter, in a radial direction and with respect to said hollow conductor.

18. The RF data line according to claim 14, wherein the RF data line extends in a longitudinal direction, and said crimp and said hollow conductor are in alignment in the longitudinal direction.

19. The RF data line according to claim 14, wherein said hollow conductor is configured as a stranded conductor.

20. The RF data line according to claim 14, wherein:
said crimp is configured as a B-crimp with two arms which engage around two holding regions; and
said conductive material is distributed uniformly over said two holding regions of said crimp.

21. The RF data line according to claim 14, wherein said crimp is configured as a round crimp and said hollow conductor collapses inward within said crimp.

22. The RF data line according to claim 14, wherein said cavity is completely closed in a region of said crimp.

23. The RF data line according to claim 14, further comprising a contact element fastened to said crimp, said contact element has a supporting section which is inserted into said cavity and is compressed in said cavity.

24. The RF data line according to claim 23, wherein said supporting section is hollow.

25. The RF data line according to claim 14, wherein:
said cavity of said hollow conductor is empty;
said cavity is filled only with air; and
additional functional elements are not present and also not provided in said cavity.

26. The RF data line according to claim 14,
wherein the RF data line is configured as a prefabricated line; and
further comprising a contact element fastened to said crimp, said contact element having an end side fastened to said hollow conductor in order to connect the RF line to a device.

27. A method for producing an RF data line, which comprises the steps of:
providing a hollow conductor composed of a conductive material surrounding a cavity; and
fastening a crimp to the hollow conductor by way of the crimp being pressed against the hollow conductor, and resulting in the conducting material being displaced into the cavity.

28. A method of using a line, which comprises the steps of:
forming the line as a radio frequency data line having a hollow conductor composed of a conductive material surrounding a cavity, and a crimp fastened to the hollow conductor and pressing against the hollow conductor resulting in the conductive material being displaced into the cavity; and
using the RF data line for transmitting data at frequencies in a gigahertz range.
